(19) United States
(12) Patent Application Publication
(10) Pub. No.: US 2026/0365130 A1
(43) Pub. Date: Nov. 19, 2026

(54) IN-VEHICLE SYSTEM AND METHOD FOR CONTROLLING IN-VEHICLE SYSTEM

(71) Applicant: DENSO CORPORATION, Kariya-city (JP)

(72) Inventors: Sho MATSUMOTO, Kariya-city (JP); Tomohisa KISHIGAMI, Kariya-city (JP)

(21) Appl. No.: 19/424,748

(22) Filed: Dec. 18, 2025

(30) Foreign Application Priority Data
Dec. 24, 2024 (JP) 2024-228005

(51) Int. Cl. B60R 16/03; B60R 16/023

(52) U.S. Cl. CPC B60R 16/03; B60R 16/023

(57) ABSTRACT

An in-vehicle system includes: control devices mounted on a vehicle. The control devices include at least one lower-level control device and at least one higher-level control device disposed in a higher level of the at least one lower-level control device. The at least one higher-level control device has a relay control unit that turns on or off a relay circuit provided in a power supply line of the at least one lower-level control device. The in-vehicle system further includes: a current detection unit that detects an amount of current flowing through the power supply line of the at least one lower-level control device. The relay control unit is configured to turn off the relay circuit when the amount of current detected by the current detection unit reaches a predetermined amount of current that indicates a hibernation state of the at least one lower-level control device.

### CROSS REFERENCE TO RELATED APPLICATION

The present application claims the benefit of priority from Japanese Patent Application No. 2024-228005 filed on Dec. 24, 2024. The entire disclosure of the above application is incorporated herein by reference.

### TECHNICAL FIELD

The present disclosure relates to an in-vehicle system having a plurality of control devices mounted on a vehicle, and a method for controlling the in-vehicle system.

### BACKGROUND

For example, a conceivable technique teaches an in-vehicle network system including a higher-level ECU, an intermediate-level ECU, and a lower-level ECU. In the in-vehicle network system of the conceivable technique, the intermediate-level ECU is supplied with power from a power source and has a relay that can switch between the supplying and the cutting off of the power from the power source to the lower-level ECU. The intermediate-level ECU closes the relay to supply the power from the power source to the lower-level ECU in response to a message received from the higher-level ECU. In other words, the intermediate-level ECU maintains the lower-level ECU in a power cutoff state until the intermediate-level ECU receives a message from the higher-level ECU. The lower-level ECU transitions from the power cutoff state to a standby state in which the lower-level ECU waits for an instruction when the power is supplied to the lower-level ECU.

### SUMMARY

According to an example, an in-vehicle system may include: a plurality of control devices mounted on a vehicle. The plurality of control devices include at least one lower-level control device and at least one higher-level control device disposed in a higher level of the at least one lower-level control device. The at least one higher-level control device has a relay control unit that turns on or off a relay circuit provided in a power supply line of the at least one lower-level control device. The in-vehicle system may further include: a current detection unit that detects an amount of current flowing through the power supply line of the at least one lower-level control device. The relay control unit is configured to turn off the relay circuit when the amount of current detected by the current detection unit reaches a predetermined amount of current that indicates a hibernation state of the at least one lower-level control device.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing an example of the configuration of an in-vehicle system according to a first embodiment;

FIG. 2 is a diagram illustrating an example of an NM message and a method for realizing partial networking using the NM message;

FIG. 3 is a flowchart showing an example of a process executed by the first and second intermediate-level ECUs to control the on and off state of the first to third relay circuits;

FIG. 4 is a flowchart showing an example of a first relay-off determination process in step S160 of the flowchart of FIG. 3;

FIG. 5 is a flowchart showing an example of a second relay-off determination process in step S170 of the flowchart of FIG. 3;

FIG. 6 is a diagram for explaining first to fourth threshold values for determining the amount of current flowing through the power supply lines of the first to third lower-level ECUs;

FIG. 7 is a flowchart showing an example of a process executed by the first and second intermediate-level ECUs to control the on and off state of the first to third relay circuits in the second embodiment;

FIG. 8 is a diagram for explaining a method for determining the occurrence of an anomaly such as an open failure in the third embodiment; and

FIG. 9 is a diagram showing an example of the configuration of an in-vehicle system according to a modification example.

### DETAILED DESCRIPTION

In the system of the conceivable technique, when the higher-level ECU determines that it is no longer necessary to operate the lower-level ECU, the higher-level ECU transmits a message for instructing the lower-level ECU to transition to a standby state and instructing the intermediate-level ECU to open the relay.

However, if the intermediate-level ECU opens the relay without depending on the situation in the lower-level ECU, there is a possibility that a malfunction may occur in the processing of the lower-level ECU. For example, after completing the processing to execute a specific function, the lower-level ECU may execute a predetermined termination processing such as a data back up process for the processing progress and learning results, or a transition processing to an initial position of an actuator. In such a case, if the relay circuit is opened while the lower-level ECU is executing a predetermined termination process, there is a possibility that necessary processes such as the data backup process and the transition processing to an initial position of an actuator cannot be completed.

The present embodiments have been made in view of the above points, and provides an in-vehicle system and a method for controlling the in-vehicle system that is capable of cutting off the power supply to a lower-level control device, which receives the power via a relay circuit, at a proper timing.

In order to achieve the above object, an in-vehicle system according to the present embodiments is an in-vehicle system having a plurality of control devices mounted on a vehicle. The plurality of control devices include at least one lower-level control device and at least one higher-level control device disposed in a higher level of the lower-level control device. The higher-level control device has a relay control unit that turns on or off a relay circuit provided in a power supply line of the lower-level control device. The in-vehicle system further includes a current detection unit that detects an amount of current flowing through the power supply line of the lower-level control device. The relay control unit is configured to turn off the relay circuit when the amount of current detected by the current detection unit reaches a predetermined amount of current that indicates a sleep state of the lower-level control device.

Further, a method for controlling an in-vehicle system according to the present embodiments is a control method for an in-vehicle system having a plurality of control devices mounted on a vehicle. The plurality of control devices include at least one lower-level control device and at least one higher-level control device disposed in a higher level of the lower-level control device. The higher-level control device has a relay control unit that turns on or off a relay circuit provided in a power supply line of the lower-level control device. The in-vehicle system further includes a current detection unit that detects an amount of current flowing through the power supply line of the lower-level control device. The method for controlling the in-vehicle system includes: detecting the amount of current flowing through the power supply line using the current detection unit; and turning off the relay circuit using the relay control unit when the amount of current detected by the current detection unit reaches a predetermined amount of current that indicates a sleep state of the lower-level control device.

In the in-vehicle system and the method for controlling the in-vehicle system according to the present embodiments, the relay control unit of the higher-level control device turns off the relay circuit based on the amount of current detected by the current detection unit reaches the predetermined amount of current indicating the sleep state of the lower-level control device, as described above.

Therefore, according to the in-vehicle system and the method for controlling the in-vehicle system according to the present embodiments, it is possible to avoid the power supply to the lower-level control device being cut off while the lower-level control device is executing a certain processing. In other words, it becomes possible to cut off the power supply to the lower-level control device at a proper timing when the lower-level control device transitions to a sleep state.

The reference signs and/or numerals in parentheses are merely added to indicate examples of correspondence relationships with concrete structures in the below-described embodiments in order to facilitate the understanding of the present disclosure, which has no intention to limit the scope of the present disclosure in any manner.

Technical features described in the following sections other than the above-mentioned features become apparent from the description of the embodiments and the accompanying drawings.

Hereinafter, an embodiment of an in-vehicle system and a method for controlling an in-vehicle system according to the present embodiments will be described with reference to the drawings. The present disclosure is not limited to the following embodiments, and various modified examples described below are also included in the technical scope of the present disclosure. In addition to the following embodiment, various modifications can be made without departing from the spirit and scope of the present disclosure. The embodiments and various modified examples can be combined within a scope that does not cause technical inconsistency. In the following description, the same or similar components may be denoted by the same reference symbol throughout the drawings, and descriptions thereof may be omitted. In addition, in a case where only a part of the configuration is referred to in an embodiment or modification example, the description in the foregoing embodiment may be applied to the remaining configuration.

### First Embodiment

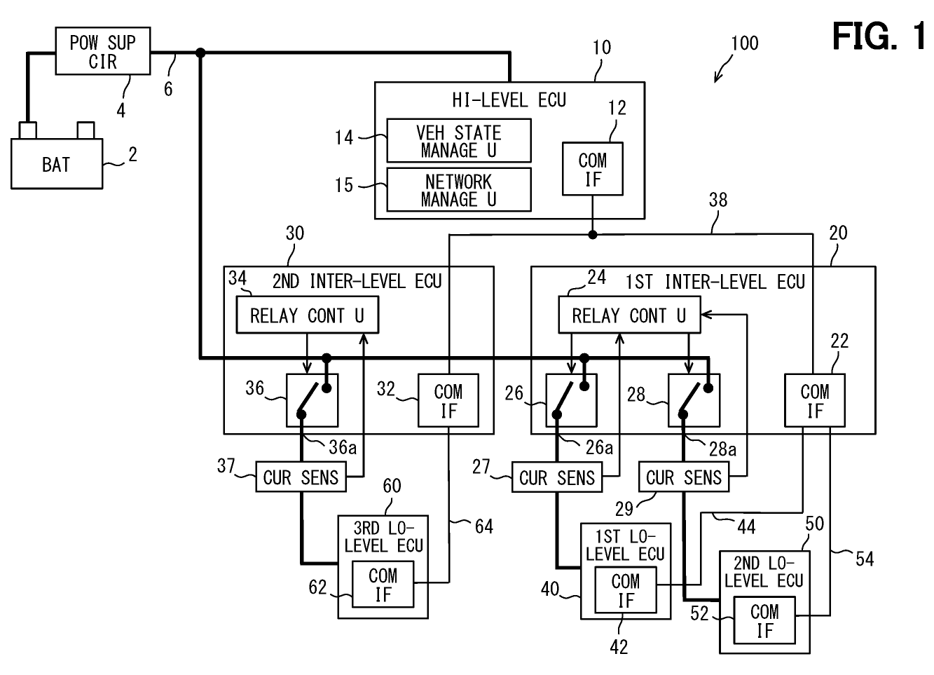

FIG. 1 is a diagram showing an example of the configuration of an in-vehicle system 100 according to a first embodiment. The in-vehicle system 100 shown in FIG. 1 includes a higher-level ECU 10 as a higher level control device, first and second intermediate-level ECUs 20, 30 as high-level side control devices, and first to third lower-level ECUs 40, 50, 60 as lower-level control devices. ECU is an abbreviation for Electronic Control Unit. In this embodiment, the higher-level ECU 10, the first and second intermediate-level ECUs 20, 30, and the first to third lower-level ECUs 40, 50, 60 are each mounted on a vehicle. The vehicle includes a passenger car, a motorcycle, a transportation vehicle, a construction vehicle, an agricultural vehicle, and the like.

The in-vehicle system 100 operates by receiving power supply from a battery 2 mounted on the vehicle. More specifically, the power from the battery 2 is provided via a power supply circuit 4 to the higher-level ECU 10, the first and second intermediate-level ECUs 20, 30, and the first to third lower-level ECUs 40 50 , 60 of the in-vehicle system 100. The power supply circuit 4 can convert, as necessary, the power supply voltage of the battery 2 mounted on the vehicle into the operation voltages for the higher-level ECU 10, the first and second intermediate-level ECUs 20 and 30, and the first to third lower-level ECUs 40, 50, and 60. The power supply lines 6 for the first to third lower-level ECUs 40, 50, and 60 are provided with first to third relay circuits 26, 28, and 36, whose on and off states are switched by the first and second intermediate-level ECUs 20 and 30.

The configuration of the in-vehicle system 100 is not limited to the example shown in FIG. 1. For example, the number of higher-level ECUs 10 may be two or more, rather than just one. In this case, an intermediate-level ECU and a lower-level ECU are arranged below each higher-level ECU. Two or more higher-level ECUs 10 may be connected to each other so that they can communicate with each other. Furthermore, one of the intermediate-level ECUs 20, 30 may also execute the functions of the higher-level ECU 10, so that the higher-level ECU 10 may be omitted. The number of intermediate-level ECUs 20, 30 arranged below the higher-level ECU may not be two, but may be one, or may be three or more. With respect to the lower-level ECUs 40, 50, and 60, multiple lower-level ECUs may be connected to a single relay circuit 26, 28, or 36. Additionally, one or some of the lower-level ECUs 40, 50, and 60 may be supplied with power directly from the power supply circuit 4, without passing through the relay circuits 26, 28, or 36.

The higher-level ECU 10, the first and second intermediate-level ECUs 20 and 30, and the first to third lower-level ECUs 40, 50, and 60 may each be formed of a computer equipped with components such as a processor, memory, and storage. For example, the processor is a CPU (Central Processing Unit), an MPU (Micro Processing Unit), a GPU (Graphics Processing Unit), or a DFP (Data Flow Processor), each of which is capable of executing a predetermined process according to a program. The memory is a volatile storage medium, such as a RAM (Random Access Memory), that temporarily stores results of arithmetic processing executed by the processor. The storage is a non-volatile storage medium, such as flash memory or ROM (i.e., Read Only Memory). The storage stores various data and programs executed by the processor.

Furthermore, the storage can store backup data such as processing progress and learning results, for example, by a predetermined termination process that the first to third lower-level ECUs 40, 50, 60 execute when the control process ends. The predetermined processing of the present embodiments includes a predetermined control processing and a predetermined termination processing. The control processing and the termination processing will be described in detail later. It should be noted that some or all of the functions provided by the higher-level ECU 10, the first and second intermediate-level ECUs 20 and 30, and the first to third lower-level ECUs 40, 50, and 60 may be implemented not by software such as a program, but by hardware, for example, using an ASIC (Application Specific Integrated Circuit) or an FPGA (Field-Programmable Gate Array).

The higher-level ECU 10, the first and second intermediate-level ECUs 20 and 30, and the first to third lower-level ECUs 40, 50, and 60 are further provided with communication interfaces (i.e., communication IFs) 12, 22, 32, 42, 52, and 62 for communicating with other ECUs via communication buses 38, 44, 54, and 64.

The communication IF 12 of the higher-level ECU 10 is connected to the communication IFs 22 and 32 of the first and second intermediate-level ECUs 20 and 30 via the communication bus 38. The first and second intermediate-level ECUs 20 and 30 can also communicate with each other via the communication bus 38. Here, the communication bus that connects the higher-level ECU 10 with the first and second intermediate-level ECUs 20 and 30, and the communication bus that connects the first and second intermediate-level ECUs 20 and 30 with each other, may be provided separately. The communication IF 22 of the first intermediate-level ECU 20 is further connected to the communication IF 42 of the first lower-level ECU 40 via the communication bus 44. In addition, the communication IF 22 of the first intermediate-level ECU 20 is connected to the communication IF 52 of the second lower-level ECU 50 via the communication bus 54. The communication IF 42 of the first lower-level ECU 40 and the communication IF 52 of the second lower-level ECU 50 may be connected to the communication IF 22 of the first intermediate-level ECU 20 via a common communication bus. The communication IF 32 of the second intermediate-level ECU 30 is connected to the communication IF 62 of the third lower-level ECU 60 via the communication bus 64. The communication IFs 22 and 32 of the first and second intermediate-level ECUs 20 and 30 are configured to serve as gateways when the higher-level ECU 10 and the first to third lower-level ECUs 40, 50, and 60, which are connected to different communication buses 38, 44, 54, and 64, communicate with each other.

The in-vehicle system 100 can use CAN (registered trademark, the same applies hereinafter) as the communication protocol for enabling the respective communication IFs 12, 22, 32, 42, 52, and 62 of the higher-level ECU 10, the first and second intermediate-level ECUs 20 and 30, and the first to third lower-level ECUs 40, 50, and 60 to communicate with each other. CAN is an abbreviation of Controller Area Network. It should be noted that the communication protocol is not limited to CAN. The in-vehicle system 100 can employ various communication protocols such as Ethernet (registered trademark), LIN (Local Interconnect Network), FlexRay (registered trademark), and CAN-FD (CAN with Flexible Data Rate). For example, different communication protocols may be adopted for the different communication buses 38, 44, 54, and 64.

The higher-level ECU 10 can have a function as a domain controller that supervises the control of the first and second intermediate-level ECUs 20 and 30 and the first to third lower-level ECUs 40, 50, and 60. A domain refers to a functional unit when vehicle functions are broadly divided into a powertrain domain, a chassis domain, an advanced driver assistance domain, a body domain, a cockpit domain, and the like. For example, if the domain controller of the powertrain domain is the higher-level ECU 10, the first to third lower-level ECUs 40, 50, 60 include various ECUs for controlling the vehicle's powertrain, such as an engine ECU, a motor (or inverter) ECU, a battery monitoring ECU, and a transmission ECU. Furthermore, when the domain controller of the chassis domain is the higher-level ECU 10, the first to third lower-level ECUs 40, 50, 60 include various ECUs for controlling the chassis of the vehicle, such as a steering ECU, a brake ECU, and a suspension ECU.

The above is an example for dividing the functional domains, and the domains divided in accordance with the function may be different from the above-described example. Alternatively, the higher-level ECU 10 may function as an area controller that supervises the control of the first and second intermediate-level ECUs 20, 30 and the first to third lower-level ECUs 40, 50, 60 arranged in each area of the vehicle (e.g., front, rear, right, and left sides, and the like).

The higher-level ECU 10 has a vehicle state management unit 14 that transmits vehicle state information relating to the vehicle status to the first and second intermediate-level ECUs 20, 30 and the first to third lower-level ECUs 40, 50, 60 based on the vehicle state (e.g., vehicle state such as moving vehicle state, stopped vehicle state, parked vehicle state and the like, and/or state of user operation of various vehicle functions) grasped from information acquired from sensors and other ECUs. It should be noted that the vehicle state management unit 14 may be provided not in the higher-level ECU 10, but in another ECU such as the first or second intermediate-level ECU 20 or 30. Furthermore, functions of the vehicle state management unit 14 may be distributed across multiple ECUs. In this case, the ECU that receives the vehicle state information can acquire the necessary vehicle state information by integrating or selecting from among multiple pieces of vehicle state information acquired from multiple ECUs.

Based on the vehicle state information from the vehicle state management unit 14, the first and second intermediate-level ECUs 20, 30 can determine whether or not the activation and operation of the first to third lower-level ECUs 40, 50, 60 is necessary. That is, the first and second intermediate-level ECUs 20, 30 store, as a table and a list in advance, the vehicle state information required for the activation and operation of the first to third lower-level ECUs 40, 50, 60 associated with the first to third lower-level ECUs 40, 50, 60. By referring to the stored table and list, the first and second intermediate-level ECUs 20, 30 can determine whether or not the activation and operation of the first to third lower-level ECUs 40, 50, 60 is necessary based on the vehicle state information. Then, when the first and second intermediate-level ECUs 20, 30 determine that at least one of the first to third lower-level ECUs 40, 50, 60 needs to be activated and operated, the first and second intermediate-level ECUs 20, 30 turn on one of the first to third relay circuits 26, 28, 36 corresponding to the at least one of the first to third lower-level ECUs 40, 50, 60 that is determined to need to be activated and operated. On the other hand, when the first and second intermediate-level ECUs 20, 30 determine that the activation and operation of the first to third lower-level ECUs 40, 50, 60 is unnecessary, the first and second intermediate-level ECUs 20, 30 turn off one of the first to third relay circuits 26, 28, 36 corresponding to one of the first to third lower-level ECUs 40, 50, 60 that is determined not to need to be activated and operated, with taking into consideration the amount of current detected by the first to third current sensors 27, 29, 37 described below.

In addition to or instead of transmitting the vehicle state information, the vehicle state management unit 14 may transmit a communication message (i.e., relay control message) to the first and second intermediate-level ECUs 20, 30 to instruct the first to third relay circuits 26, 28, 36 to be turned on or off. In this case, the vehicle state management unit 14 may store in advance, in the form of a table or list, the vehicle state information that is required to activate and operate each of the first to third lower-level ECUs 40, 50, 60 in association with the first to third lower-level ECUs 40, 50, 60. The vehicle state management unit 14 can then refer to the stored table and list to determine, based on the state of the vehicle, whether or not the activation and operation of the first to third lower-level ECUs 40, 50, 60 is necessary. Then, when the vehicle state management unit 14 determines that the activation and operation of at least one of the first to third lower-level ECUs 40, 50, 60 is necessary, the vehicle state management unit 14 transmits a communication message to the intermediate-level ECUs 20, 30 to instruct the intermediate-level ECUs 20, 30 to turn on the relay circuits 26, 28, 36 corresponding to the relevant lower-level ECUs 40, 50, 60. In this case, the first and second intermediate-level ECUs 20, 30 turn on the first to third relay circuits 26, 28, 36 in response to the received communication message. On the other hand, if the vehicle state management unit 14 determines that the first to third lower-level ECUs 40, 50, 60 do not need to be activated and operated, the vehicle state management unit 14 may transmit a communication message to the intermediate-level ECUs 20, 30 to instruct the intermediate-level ECUs 20, 30 to turn off the first to third relay circuits 26, 28, 36. In this case, the first and second intermediate-level ECUs 20, 30 turn off the first to third relay circuits 26, 28, 36 in response to the received communication message, taking into consideration the amount of current detected by the first to third current sensors 27, 29, 37 described below.

Furthermore, in addition to or instead of the vehicle state management unit 14, the higher--level ECU 10 may have a network management unit 15 that transmits a network management (hereinafter, NM) message as a wake-up signal to the first and second intermediate-level ECUs 20, 30 based on the state of the vehicle and/or in response to the input of a predetermined activation trigger. A predetermined activation trigger can be considered to be input, for example, when the vehicle door lock is unlocked by operating a mobile key carried by the user or by operating the door handle, when the vehicle's main switch is turned on, or when a notification of the occurrence of an activation trigger is received from a higher-level ECU as another domain controller.

Here, the NM message will be explained. In this embodiment, partial networking is realized by the NM message, so that the first to third lower-level ECUs 40, 50, 60 are each assigned a cluster to which each of the first to third lower-level ECUs 40, 50, 60 belongs from among a plurality of divided clusters. Here, the partial networking indicates that only ECUs belonging to some clusters are activated (i.e., in an operation state), and ECUs belonging to the remaining clusters are in a power cut-off state or in a sleep state. In this way, by turning on only the ECUs that need to be operated, it is possible to reduce the power consumption of each ECU mounted on the vehicle. The information of the assigned cluster is stored as cluster setting information (also called PNC setting information) in the first and second intermediate-level ECUs 20 and 30 that are positioned in the upper level of the respective lower-level ECUs 40, 50 and 60.

If the received NM message includes activation cluster information (also called PN request information) that designates the cluster to which the first to third lower-level ECUs 40, 50, 60 belong as the activation cluster, the first and second intermediate-level ECUs 20, 30 turn on the relay circuits 26, 28, 36 corresponding to the respective first to third lower-level ECUs 40, 50, 60. The network management unit 15 can change the PN request information included in the NM message depending on the state of the vehicle and/or the factor why the activation trigger was input. Therefore, the network management unit 15 can transmit an NM message that selectively activates and operates the first to third lower-level ECUs 40, 50, and 60.

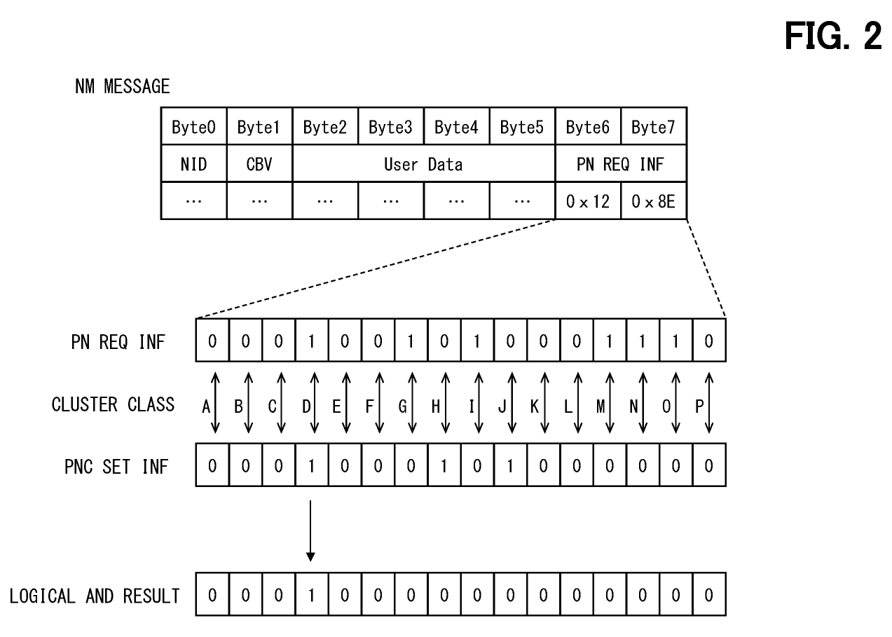

FIG. 2 shows an example of an NM message. In the example shown in FIG. 2, the NM message includes data in bytes 0 to 7. Byte 0 includes the node ID (i.e., NID). The node ID is a unique identifier assigned to each of the higher-level ECU 10, the first and second intermediate-level ECUs 20 and 30, and the first to third lower-level ECUs 40, 50, and 60. The node ID enables identification of a transmission source of the NM message. Byte 1 includes control bit vector (CBV). The control bit vector includes data indicating whether the partial networking is in use. When the control bit vector indicates the use of partial networking, the user data area of bytes 2 to 7 includes the PN request information, which is activation cluster information indicating the cluster to be activated.

In the example shown in FIG. 2, the control bit vector indicates the use of partial networking and the PN request information is stored in bytes 6 and 7 of the user data area. The user data area of bytes 2 to 5 may be used to transmit arbitrary information such as activation factors of ECU or information regarding normal or anomaly states. It should be noted that FIG. 2 shows only one example of the format of the NM message, and the NM message may be in another format as long as the NM message includes the PN request information. For example, the NID and CBV may be omitted.

The PN request information indicates which clusters should be activated and which clusters do not need to be activated for each of the multiple divided clusters. More specifically, in the example shown in FIG. 2, the clusters are classified into 16 clusters in advance. The PN request information includes 16-bit data respectively corresponding to the 16 clusters. That is, the 16-bit data of the PN request information is previously associated with the 16 clusters. When a bit in 16-bit data of the PN request information is "0", the data indicates that the activation of the corresponding cluster is not required. When a bit in 16-bit data of the PN request information is "1", the data indicates that the activation of the corresponding cluster is required. It should be noted that the PN request information may indicate only the clusters that need to be activated. Alternatively, the PN request information may indicate only the clusters that do not need to be activated.

FIG. 2 also shows an example of the PNC setting information set for the first to third lower-level ECUs 40, 50, and 60. In the PNC setting information shown in FIG. 2, if the associated clusters are classified as A to P from left to right in the drawing, the PNC setting information in FIG. 2 indicates that the lower-level ECUs to which this PNC setting information is set belong to clusters D, H, and J. Since the first to third lower-level ECUs 40, 50, and 60 are capable of realizing various functions by executing a program and the like, the first to third lower-level ECUs 40, 50, and 60 can belong to one or more clusters.

The first and second intermediate-level ECUs 20, 30 can receive the NM message including the PN request information via their respective communication IFs 22, 32. When receiving the NM message, the first and second intermediate-level ECUs 20, 30 compare the PN request information of the NM message with the PNC setting information of the subordinate first to third lower-level ECUs 40, 50, 60 bit by bit, as shown in FIG. 2, and calculate, for example, a logical conjunction.

Then, the first and second intermediate-level ECUs 20, 30 determine whether the cluster requested to be activated by the PN request information in the NM message matches the cluster in the PNC setting information set for the subordinate first to third lower-level ECUs 40, 50, 60. For example, in the example shown in FIG. 2, the clusters for which activation is requested by the PN request information include clusters D, G, I, M, N, and O. The clusters to which the lower ECUs belong, as indicated by the PNC setting information, are clusters D, H, and J. In this case, for the cluster D, the cluster requested to be activated by the PN request information included in the NM message matches the cluster set in the PNC setting information. Therefore, the calculation result of logical conjunction is "1" in cluster D, as shown in FIG. 2.

If any bit becomes "1" as a result of the logical conjunction, the first and second intermediate-level ECUs 20, 30 determine that activation of the lower-level ECU for which the PNC setting information shown in FIG. 2 is set is requested. In response to this determination result, the first and second intermediate-level ECUs 20, 30 turn on the relay circuits corresponding to the lower ECUs for which the PNC setting information shown in FIG. 2 is set. If the relay circuit is already turned on, the first and second intermediate-level ECUs 20, 30 keep the relay circuit turned on. On the other hand, if the result of the logical conjunction is that none of the bits are "1" and all of the bits are "0", the first and second intermediate-level ECUs 20, 30 determine that there is no request to activate the lower-level ECU for which the PNC setting information shown in FIG. 2 is set. In this case, the first and second intermediate-level ECUs 20 and 30 turn off the relay circuits corresponding to the lower-level ECUs for which the PNC setting information shown in FIG. 2 is set, taking into consideration the amount of current detected by the first to third current sensors 27, 29, and 37 described later.

Here, It is also possible to set the PNC setting information for the higher-level ECU 10 and/or the first and second intermediate-level ECUs 20, 30 so that the activation state (i.e., the operation state) and the sleep state can be switched by an NM message. Alternatively, the higher-level ECU 10 and/or the first and second intermediate-level ECUs 20, 30 may be configured to go into a sleep state when a predetermined period of time has elapsed without receiving an NM message from another ECU.

The first and second intermediate-level ECUs 20 and 30 each have, as one of their functions, a first relay control unit 24 and a second relay control unit 34, respectively. The first and second relay control units 24, 34 can determine which relay circuits 26, 28, 36 to turn on and which relay circuits 26, 28, 36 to keep off based on the vehicle state information and/or the communication message (i.e., the relay control message and the NM messages). In other words, by referring to the above-mentioned table and list, the first and second relay control units 24, 34 can determine which relay circuits 26, 28, 36 should be turned on and which relay circuits 26, 28, 36 should be turned off based on the acquired vehicle state information. Furthermore, the first and second relay control units 24, 34 can determine which relay circuits 26, 28, 36 should be turned on and which relay circuits 26, 28, 36 should be turned off based on the communication message.

The first intermediate-level ECU 20 has the first and second relay circuits 26 and 28, and the second intermediate-level ECU 30 has the third relay circuit 36. The first relay control unit 24 of the first intermediate-level ECU 20 turns on or off the first and second relay circuits 26, 28 in accordance with the determination result based on the vehicle state information and the received communication message. The second relay control unit 34 of the second intermediate-level ECU 30 also turns on or off the third relay circuit 36 in accordance with the determination result based on the vehicle state information and the received communication message.

The first relay circuit 26 is provided on the power supply line 6 for supplying power to the first lower-level ECU 40. In other words, the power line of the first lower-level ECU 40 is connected to a first power port 26a, which is connected to the first relay circuit 26. The second relay circuit 28 is provided on the power supply line 6 for supplying electric power to the second lower-level ECU 50. In other words, the power line of the second lower-level ECU 50 is connected to a second power port 28a, which is connected to the second relay circuit 28. The third relay circuit 36 is provided on the power supply line 6 for supplying power to the third lower-level ECU 60. In other words, the power line of the third lower-level ECU 40 is connected to the third power port 36a, which is connected to the third relay circuit 36.

The first to third relay circuits 26, 28, and 36 may be formed of semiconductor switches such as MOSFETs or IGBTs. However, the first to third relay circuits 26, 28, and 36 may be formed of ordinary mechanical relays, which are different from the semiconductor switches. Further, the first to third relay circuits 26, 28, and 36 may be provided inside the first and second intermediate-level ECUs 20 and 30 as shown in FIG. 1, or may be provided outside the first and second intermediate-level ECUs 20 and 30.

The first to third lower-level ECUs 40, 50, 60 may be, for example, a control ECU that executes a control process to control a specific control target in a vehicle, a sensor ECU that calculates a specific physical quantity based on a detection signal detected by a sensor, or a drive ECU that outputs a drive signal to an actuator to drive the actuator. When the first and second intermediate-level ECUs 20 and 30 turn on the corresponding relay circuits 26, 28, and 36, the first to third lower-level ECUs 40, 50, and 60 are activated and become operable by the supply of power. Then, when the first to third lower-level ECUs 40, 50, 60 become operable, the first to third lower-level ECUs 40, 50, 60 execute predetermined control processes, such as a control process for controlling the control target, a control processes for calculating predetermined physical quantity based on the detection signal of the sensor, and a control process for outputting the drive signal for driving the actuator. On the other hand, the first to third lower-level ECUs 40, 50, 60 are not required to control the control target, to calculate the predetermined physical quantity, or to drive the actuator, and therefore the first to third lower-level ECUs 40, 50, 60 are in a power-off state when the corresponding relay circuits 26, 28, 36 are turned off.

The first to third lower ECUs 40, 50, 60 may be able to terminate the predetermined control process based on the completion of the execution of the predetermined control process described above. Alternatively, the first to third lower-level ECUs 40, 50, 60 may determine, based on the vehicle state information acquired from the higher-level ECU 10 or the like, whether the vehicle state has become such that the respective predetermined control processes are unnecessary. In this case, when the first to third lower-level ECUs 40, 50, 60 determine that the vehicle state has become such that the respective specific control processes are unnecessary, the first to third lower-level ECUs 40, 50, 60 may terminate the specific control processes, for example, at the timing when the specific control processes currently being executed have ended.

Then, upon completion of their respective control processing, the first to third lower-level ECUs 40, 50, and 60 execute predetermined termination processing. The predetermined termination processing may include processes for storing backup data, such as backing up data generated during each stage of the control processing and backing up learning data in cases where the control processing involves learning process. Furthermore, the predetermined termination process may include a process for returning the actuator to its initial state in preparation for the next operation. The predetermined termination process imposes a lower processing load on the first to third lower-level ECUs 40, 50, 60 than the predetermined control process. Therefore, the amount of current flowing when the first to third lower-level ECUs 40, 50, 60 are executing a predetermined termination process is smaller than the amount of current flowing when the first to third lower-level ECUs 40, 50, 60 are executing a predetermined control process.

When the first to third lower-level ECUs 40, 50, 60 complete the predetermined termination process, they enter a hibernation state (for example, a standby state). In the hibernation state, the first to third lower-level ECUs 40, 50, 60 are supplied with power but do not execute processes that consume a large amount of power, such as control processes. Therefore, the amount of current flowing when the first to third lower-level ECUs 40, 50, 60 are in a hibernation state is smaller than the amount of current flowing when the first to third lower-level ECUs 40, 50, 60 are executing a predetermined control process or a predetermined termination process.

In short, the amount of current flowing through the first to third lower-level ECUs 40, 50, 60 is greatest when the first to third lower-level ECUs 40, 50, 60 are executing a predetermined control process. The amount of current flowing through the first to third lower-level ECUs 40, 50, 60 is the second largest when the first to third lower-level ECUs 40, 50, 60 are executing the predetermined termination process. The amount of current flowing through the first to third lower-level ECUs 40, 50, 60 is smallest when the first to third lower-level ECUs 40, 50, 60 are in a hibernation state.

The first to third current sensors 27, 29, 37 detect the amount of current flowing through the power supply lines of the first to third lower -level ECUs 40, 50, 60, respectively. More specifically, the first current sensor 27 detects the amount of current flowing through the power supply line of the first lower-level ECU 40. The second current sensor 29 detects the amount of current flowing through the power supply line of the second lower-level ECU 50. The third current sensor 37 detects the amount of current flowing through the power supply line of the third lower-level ECU 60.

The amounts of current detected by the first to third current sensors 27 , 29 , 37 are input to the first and second intermediate-level ECUs 20 , 30. As a result, the first and second intermediate-level ECUs 20, 30 can determine, based on the amount of current input from the first to third current sensors 27, 29, 37, whether the corresponding first to third lower-level ECUs 40, 50, 60 are executing a predetermined control process, executing a predetermined termination process, or are in a hibernation state. In the example shown in FIG. 1, the first to third current sensors 27, 29, 37 are provided outside the first and second intermediate-level ECUs 20, 30, but they may also be provided inside the first and second intermediate-level ECUs 20, 30.

Here, if the first and second intermediate-level ECUs 20, 30 turn off the first to third relay circuits 26, 28, 36 based on vehicle state information or a communication message instructing the relay circuits to be turned off without taking into consideration the situation in the first to third lower-level ECUs 40, 50, 60, there is a possibility of difficulty such that the failure described below as an example occurs.

For example, assuming that the first intermediate-level ECU 20 turns off the first and second relay circuits 26, 28 based on the vehicle state information or a communication message, even though the first and second lower-level ECUs 40, 50 are executing the predetermined termination process. In this case, the predetermined termination process in the first and second lower-level ECUs 40, 50 is interrupted. As a result, the first and second lower-level ECUs 40, 50 may be unable to store necessary backup data or return the actuator to its initial position, for example.

Therefore, in the in-vehicle system 100 according to this embodiment, the first and second intermediate-level ECUs 20, 30 determine whether to turn on or off the first to third relay circuits 26, 28, 36 based not only on the acquired vehicle state information and/or the received communication message but also on the amount of current detected by the first to third current sensors 27, 29, 37.

More specifically, based on the amount of current detected by the first to third current sensors 27, 29, 37, the first and second intermediate-level ECUs (corresponding to the first and second relay control units 24, 34) can identify whether the first to third lower-level ECUs 40, 50, 60 are in an operation state for executing the predetermined control process or a predetermined termination process, or are in a hibernation state. Therefore, even if the acquired vehicle state information and/or the received communication message indicates that the first to third relay circuits 26, 28, 36 should be turned off, the first and second intermediate-level ECUs 20, 30 can keep the first to third relay circuits 26, 28, 36 turned on if the amount of current detected by the current sensors 27, 29, 36 on the power supply line indicates that the lower-level ECUs 40, 50, 60 are operating. This makes it possible to prevent the first to third relay circuits 26, 28, 36 from being turned off while the lower-level ECUs 40, 50, 60 are in the operation state, thereby making it possible to avoid, for example, the interruption of a predetermined termination process.

Then, the first and second intermediate-level ECUs 20, 30 turn off the first to third relay circuits 26, 28, 36 when the acquired vehicle state information and/or the received communication message indicates that the first to third relay circuits 26, 28, 36 should be turned off and when the amount of current detected by the current sensors 27, 29, 36 on the power supply line is an amount of current that indicates that the lower-level ECUs 40, 50, 60 are in a hibernation state. This allows the first to third relay circuits 26, 28, 36 to be turned off at a proper timing when the lower-level ECUs 40, 50, 60 are in a hibernation state.

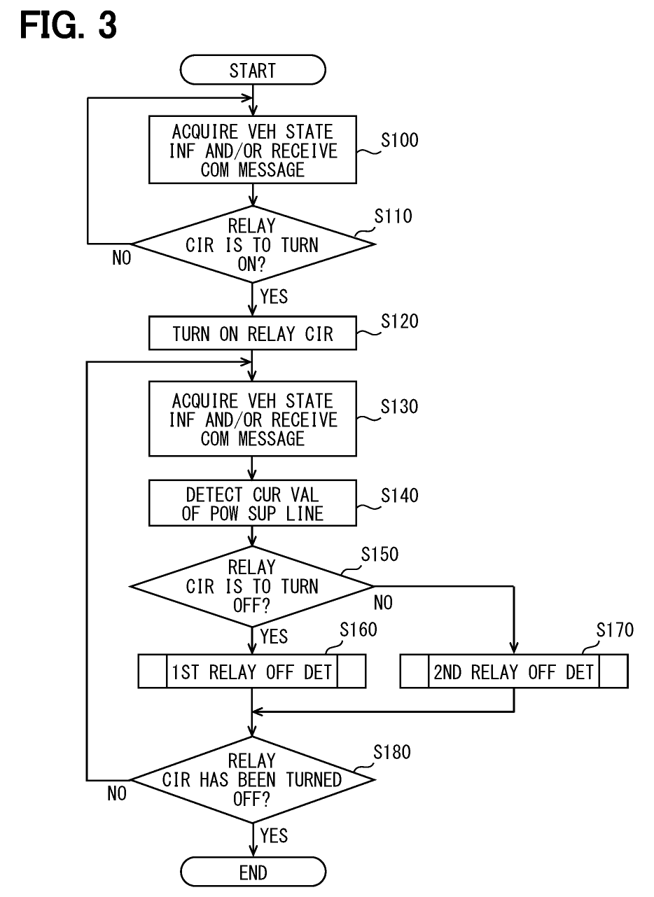

An example of the processing executed in the first and second intermediate-level ECUs 20, 30 to control the on and off state of the first to third relay circuits 26, 28, 36 will be described below with reference to the flowcharts of FIGS. 3 - 5. The first and second intermediate-level ECUs 20, 30 repeatedly execute the processes shown in the flowcharts of FIGS. 3 - 5 for each of the first to third relay circuits 26, 28, 36, respectively. The execution of the processes shown in the flowcharts described below by the first and second intermediate-level ECUs 20, 30 corresponds to the execution of the control method for the vehicle system 100 in the present embodiments.

In step S100 of the flowchart in FIG. 3, the first and second intermediate-level ECUs 20, 30 acquire the vehicle state information transmitted from the higher-level ECU 10 and the like. And/or, the first and second intermediate-level ECUs 20, 30 receive the communication message (i.e., the relay control message and the NM message) transmitted from a higher-level ECU or the like. Then, in step S110, the first and second intermediate-level ECUs 20, 30 determine, based on the acquired vehicle state information, whether or not it is necessary to turn on the first to third relay circuits 26, 28, 36, and/or whether or not a communication message has instructed them to turn on the first to third relay circuits 26, 28, 36. If it is determined that the first to third relay circuits 26, 28, 36 are to be turned on, the first and second intermediate-level ECUs 20, 30 proceed to step S120. On the other hand, if it is determined that the first to third relay circuits 26, 28, 36 are not turned on, the first and second intermediate-level ECUs 20, 30 return to the processing of step S100.

In step S120, the first and second intermediate-level ECUs 20, 30 turn on the first to third relay circuits 26, 28, 36. As a result, the first to third lower-level ECUs 40, 50, 60, which are supplied with power via the first to third relay circuits 26, 28, 36 that are turned on, become able to execute predetermined control processes. The first to third lower-level ECUs 40, 50, 60 execute the predetermined control processes independently or in cooperation with other ECUs.

In step S130, the first and second intermediate-level ECUs 20, 30 acquire the vehicle state information and/or receive the communication message in order to check for a change in the vehicle state and/or in order to receive a new communication message. In step S140, the first and second intermediate-level ECUs 20, 30 receive the amount of current detected by the first to third current sensors 27, 29, 37 and detect the amount of current flowing through the power supply lines of the first to third lower-level ECUs 40, 50, 60.

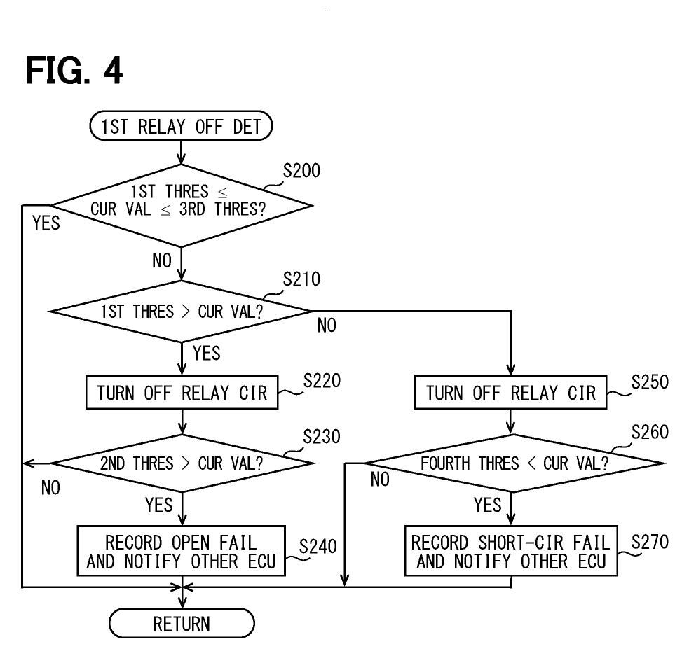

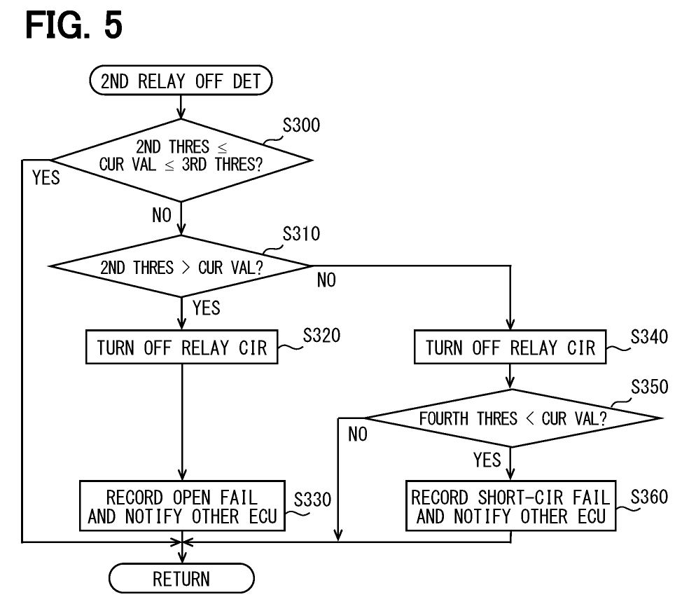

In step S150, the first and second intermediate-level ECUs 20, 30 determine, based on the acquired vehicle state information, whether it is necessary to turn off the first to third relay circuits 26, 28, 36, and/or whether a communication message has instructed them to turn off the first to third relay circuits 26, 28, 36. If it is determined that the first to third relay circuits 26, 28, 36 are to be turned off, the first and second intermediate-level ECUs 20, 30 proceed to a first relay-off determination process in step S160. On the other hand, if it is determined that the first to third relay circuits 26, 28, 36 should not be turned off, the first and second intermediate-level ECUs 20, 30 proceed to the second relay-off determination process of step S170. An example of the first relay-off determination process is shown in the flowchart of FIG. 4. An example of the second relay-off determination process is shown in the flowchart of FIG. 5.

In step S180, the first and second intermediate-level ECUs 20, 30 determine whether the first to third relay circuits 26, 28, 36 have been turned off in the first relay determination process or the second relay determination process. When it is determined that the first to third relay circuits 26, 28, 36 are turned off, the first and second intermediate-level ECUs 20, 30 temporarily terminate the processing shown in the flowchart of FIG. 3. On the other hand, if it is determined that the first to third relay circuits 26, 28, 36 are not turned off, the first and second intermediate-level ECUs 20, 30 return to the processing of step S130.

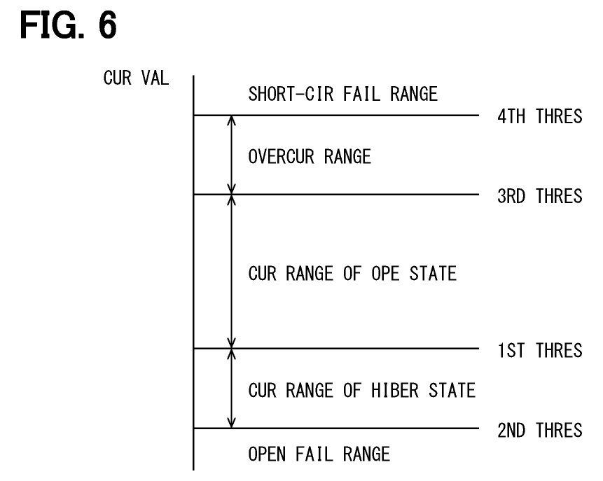

Next, the first relay-off determination process in step S160 of the flowchart in FIG. 3 will be described in detail with reference to the flowchart in FIG. 4. In step S200, the first and second intermediate-level ECUs 20, 30 determine whether the amount of current flowing through the power supply lines of the first to third lower-level ECUs 40, 50, 60 is in the range of not less than the first threshold value and not more than the third threshold value. As shown in FIG. 6, the first threshold value is a predetermined threshold value for distinguishing whether the amount of current flowing through the power supply lines of the first to third lower-level ECUs 40, 50, 60 indicates the hibernation state of the first to third lower-level ECUs 40, 50, 60 or an operation state in which the first to third lower-level ECUs 40, 50, 60 are operating. As shown in FIG. 6, the third threshold value is a threshold value that is predetermined based on the maximum amount of current flowing through the first to third lower-level ECUs 40, 50, 60 when the amount of current flowing through the power supply lines of the first to third lower-level ECUs 40, 50, 60 indicates an operation state in which the first to third lower-level ECUs 40, 50, 60 are operating. The first threshold value and the third threshold value are determined individually for each of the first to third lower-level ECUs 40 , 50 , 60.

When the amount of current flowing through the power supply lines of the first to third lower-level ECUs 40, 50, 60 is in the range of greater than or equal to the first threshold and less than or equal to the third threshold, the first to third lower-level ECUs 40, 50, 60 can be considered to be operating. Therefore, although the first and second intermediate-level ECUs 20, 30 are required to turn off the first to third relay circuits 26, 28, 36 based on the acquired vehicle state information and/or the received communication message, the first and second intermediate-level ECUs 20, 30 do not turn off the first to third relay circuits 26, 28, 36, and instead end the first relay off determination process in FIG. 4 and return to the processing in the flowchart of FIG. 3.

On the other hand, if the amount of current flowing through the power supply lines of the first to third lower-level ECUs 40, 50, 60 is not within the range of greater than or equal to the first threshold and less than or equal to the third threshold, the first and second intermediate-level ECUs 20, 30 proceed to step S210. In step S210, the first and second intermediate-level ECUs 20, 30 determine whether the amount of current flowing through the power supply lines of the first to third lower-level ECUs 40, 50, 60 is less than a first threshold value. If it is determined that the amount of current flowing through the power supply lines of the first to third lower-level ECUs 40, 50, 60 is less than the first threshold value, the first and second intermediate-level ECUs 20, 30 proceed to step S220. On the other hand, if it is determined that the amount of current flowing through the power supply lines of the first to third lower-level ECUs 40, 50, 60 is not less than the first threshold value, the first and second intermediate-level ECUs 20, 30 proceed to step S250.

If it is determined in step S210 that the amount of current flowing through the power supply lines of the first to third lower-level ECUs 40, 50, 60 is less than the first threshold value, it is satisfied that the acquired vehicle state information and/or the received communication message indicates that the first to third relay circuits 26, 28, 36 should be turned off, and the amount of current flowing through the power supply lines of the first to third lower-level ECUs 40, 50, 60 is an amount of current that indicates that the first to third lower-level ECUs 40, 50, 60 are in a hibernation state. Therefore, the first and second intermediate-level ECUs 20, 30 turn off the first to third relay circuits 26, 28, 36 in step S220.

Thereafter, the first and second intermediate-level ECUs 20, 30 proceed to step S230 and determine whether the amount of current flowing through the power supply lines of the first to third lower-level ECUs 40, 50, 60 is less than a second threshold value set to a value smaller than the first threshold value. As shown in FIG. 6, the second threshold is smaller than the first threshold and is smaller than the amount of current when the first to third lower-level ECUs 40, 50, 60 are in a hibernation state. Therefore, when the amount of current flowing through the power supply lines of the first to third lower-level ECUs 40, 50, 60 becomes less than the second threshold value, the first and second intermediate-level ECUs 20, 30 can determine that an open circuit failure has occurred in at lest one of the power supply lines of the first to third lower-level ECUs 40, 50, 60, the first to third relay circuits 26, 28, 36 connected to the first to third lower-level ECUs 40, 50, 60, and the first to third lower-level ECUs 40, 50, 60.

If the first and second intermediate-level ECUs 20, 30 determine in step S230 that the amount of current flowing through the power supply lines of the first to third lower-level ECUs 40, 50, 60 is less than the second threshold value, the process proceeds to step S240. In step S240, the first and second intermediate-level ECUs 20, 30 store the occurrence of the open circuit failure in a non-volatile memory such as their own storage. This makes it possible to easily determine the location of the failure during failure diagnosis. Furthermore, the first and second intermediate-level ECUs 20, 30 transmit a communication message to notify other ECUs that an open circuit failure has occurred in the lower-level ECU. This allows the other ECUs to acquire information about the lower-level ECU in which the open circuit failure has occurred, and to grasp that the other ECUs are unable to communicate normally with that lower-level ECU. In addition, in step S230, if it is determined that the amount of current flowing through the power supply lines of the first to third lower-level ECUs 40, 50, 60 is equal to or greater than the second threshold value, the first and second intermediate-level ECUs 20, 30 terminate the first relay-off determination process of FIG. 4 and return to the processing of the flowchart of FIG. 3.

If it is determined in step S210 that the amount of current flowing through the power supply lines of the first to third lower-level ECUs 40, 50, 60 is not less than the first threshold, then, taking into account the determination result in step S200, the amount of current is greater than the third threshold. As described above, the third threshold value is determined based on the maximum amount of current that flows through the first to third lower-level ECUs 40, 50, 60 when the first to third lower-level ECUs 40, 50, 60 are in an operation state in which the first to third lower-level ECUs 40, 50, 60 are operating. Therefore, when the amount of current is greater than the third threshold value, an excessive current is flowing through the power supply lines of the first to third lower-level ECUs 40, 50, and 60.

Therefore, the first and second intermediate-level ECUs 20, 30 turn off the first to third relay circuits 26, 28, 36 in step S250. This makes it possible to prevent excessive current from continuously flowing through the power supply lines of the first to third lower-level ECUs 40, 50, and 60. Thereafter, the first and second intermediate-level ECUs 20, 30 proceed to step S260 to determine whether the amount of current flowing through the power supply lines of the first to third lower-level ECUs 40, 50, 60 is greater than a fourth threshold value set to a value greater than the third threshold value.

As shown in FIG. 6, the fourth threshold is a threshold that is greater than the third threshold and greater than the current value of excess current that may temporarily flow in the power supply lines of the first to third lower-level ECUs 40, 50, 60 due to the influence of electromagnetic noise, and the like. Therefore, when the amount of current flowing through the power supply lines of the first to third lower-level ECUs 40, 50, 60 becomes greater than the fourth threshold value, the first and second intermediate-level ECUs 20, 30 can determine that a short circuit failure has occurred in at least one of the power supply lines of the first to third lower-level ECUs 40, 50, 60, the first to third relay circuits 26, 28, 36 connected to the first to third lower-level ECUs 40, 50, 60, and the first to third lower-level ECUs 40, 50, 60.

If the first and second intermediate-level ECUs 20, 30 determine in step S260 that the amount of current flowing through the power supply lines of the first to third lower-level ECUs 40, 50, 60 is greater than the fourth threshold value, the process proceeds to step S270. In step S270, the first and second intermediate-level ECUs 20, 30 store the occurrence of the short circuit fault in a non-volatile memory such as their own storage. This makes it possible to easily determine the location of the failure during failure diagnosis. Furthermore, the first and second intermediate-level ECUs 20, 30 transmit a communication message to notify other ECUs that a short circuit failure has occurred in the lower-level ECU. This allows the other ECUs to acquire information about the lower-level ECU in which the short circuit has occurred, and to grasp that the other ECU cannot communicate normally with that lower-level ECU. In addition, in step S260, if it is determined that the amount of current flowing through the power supply lines of the first to third lower-level ECUs 40, 50, 60 is equal to or less than the fourth threshold value, the first and second intermediate-level ECUs 20, 30 terminate the first relay-off determination process of FIG. 4 and return to the processing of the flowchart of FIG. 3.

Next, the second relay-off determination process in step S170 of the flowchart in FIG. 3 will be described in detail with reference to the flowchart in FIG. 5. In the second relay-off determination process, since the acquired vehicle state information and/or the received communication message do not indicate that the first to third relay circuits 26, 28, 36 should be turned off, the first and second intermediate-level ECUs 20, 30 execute anomaly determination equivalent to the excessive current determination (at steps S200, S210), the open circuit failure determination (at step S230), and the short circuit failure determination (at step S270) in the first relay-off determination process described above. If any anomaly is detected, the first and second intermediate-level ECUs 20, 30 take necessary measures such as turning off the relay circuit, storing the failure, and notifying the failure.

In step S300, the first and second intermediate-level ECUs 20, 30 determine whether the amount of current flowing through the power supply lines of the first to third lower-level ECUs 40, 50, 60 is in the range of not less than the second threshold value and not more than the third threshold value. In other words, in step S300, the first and second intermediate-level ECUs 20, 30 determine whether the amount of current flowing through the power supply lines of the first to third lower-level ECUs 40, 50, 60 indicates that the first to third lower-level ECUs 40, 50, 60 are in an operating state in which the first to third lower-level ECUs 40, 50, 60 are operating or in a hibernation state.

When the amount of current flowing through the power supply line of the first to third lower-level ECUs 40, 50, 60 is in the range equal to or greater than the second threshold and equal to or less than the third threshold, the first to third lower-level ECUs 40, 50, 60 can be considered to be in an operation state or a hibernation state. In other words, the amount of current flowing through the power supply lines of the first to third lower-level ECUs 40, 50, 60 does not indicate the occurrence of an anomaly. Therefore, in step S300, if it is determined that the amount of current flowing through the power supply lines of the first to third lower-level ECUs 40, 50, 60 is in the range equal to or greater than the second threshold and equal to or less than the third threshold, the first and second intermediate-level ECUs 20, 30 terminate the second relay-off determination process of FIG. 5 and return to the processing of the flowchart of FIG. 3.

On the other hand, if the amount of current flowing through the power supply lines of the first to third lower-level ECUs 40, 50, 60 is not within the range equal to or greater than the second threshold and equal to or less than the third threshold, the first and second intermediate-level ECUs 20, 30 proceed to step S310. In step S310, the first and second intermediate-level ECUs 20, 30 determine whether the amount of current flowing through the power supply lines of the first to third lower-level ECUs 40, 50, 60 is less than a second threshold value. If it is determined that the amount of current flowing through the power supply lines of the first to third lower-level ECUs 40, 50, 60 is less than the second threshold value, the first and second intermediate-level ECUs 20, 30 proceed to step S320. On the other hand, if it is determined that the amount of current flowing through the power supply lines of the first to third lower-level ECUs 40, 50, 60 is not less than the second threshold value, the first and second intermediate-level ECUs 20, 30 proceed to step S340.

Therefore, in step S310, when the amount of current flowing through the power supply lines of the first to third lower-level ECUs 40, 50, 60 becomes less than the second threshold value, the first and second intermediate-level ECUs 20, 30 can determine that an open circuit failure has occurred in at lest one of the power supply lines of the first to third lower-level ECUs 40, 50, 60, the first to third relay circuits 26, 28, 36 connected to the first to third lower-level ECUs 40, 50, 60, and the first to third lower-level ECUs 40, 50, 60. Therefore, the first and second intermediate-level ECUs 20, 30 turn off the first to third relay circuits 26, 28, 36 in step S320.

After that, the process proceeds to step S330, the first and second intermediate-level ECUs 20, 30 store the occurrence of the open circuit failure in a non-volatile memory such as their own storage. This makes it possible to easily determine the location of the failure during failure diagnosis. Furthermore, the first and second intermediate-level ECUs 20, 30 transmit a communication message to notify other ECUs that an open circuit failure has occurred in the lower-level ECU. This allows the other ECUs to acquire information about the lower-level ECU in which the open circuit failure has occurred, and to grasp that the other ECUs are unable to communicate normally with that lower-level ECU.

If it is determined in step S310 that the amount of current flowing through the power supply lines of the first to third lower-level ECUs 40, 50, 60 is not less than the second threshold, then, taking into account the determination result in step S300, the amount of current is greater than the third threshold. Therefore, the first and second intermediate-level ECUs 20, 30 turn off the first to third relay circuits 26, 28, 36 in step S340. This makes it possible to prevent excessive current from continuously flowing through the power supply lines of the first to third lower-level ECUs 40, 50, and 60. Thereafter, the first and second intermediate-level ECUs 20, 30 proceed to step S350 to determine whether the amount of current flowing through the power supply lines of the first to third lower-level ECUs 40, 50, 60 is greater than a fourth threshold value.

If the first and second intermediate-level ECUs 20, 30 determine in step S350 that the amount of current flowing through the power supply lines of the first to third lower-level ECUs 40, 50, 60 is greater than the fourth threshold value, the process proceeds to step S360. In step S360, the first and second intermediate-level ECUs 20, 30 store the occurrence of the short circuit fault in a non-volatile memory such as their own storage. This makes it possible to easily determine the location of the failure during failure diagnosis. Furthermore, the first and second intermediate-level ECUs 20, 30 transmit a communication message to notify other ECUs that a short circuit failure has occurred in the lower-level ECU. This allows the other ECUs to acquire information about the lower-level ECU in which the short circuit has occurred, and to grasp that the other ECU cannot communicate normally with that lower-level ECU. In addition, in step S350, if it is determined that the amount of current flowing through the power supply lines of the first to third lower-level ECUs 40, 50, 60 is equal to or less than the fourth threshold value, the first and second intermediate-level ECUs 20, 30 terminate the second relay-off determination process of FIG. 5 and return to the processing of the flowchart of FIG. 3.

As described above, in the in-vehicle system 100 according to the first embodiment, the first and second intermediate-level ECUs 20, 30 (and corresponding first and second relay control units 24, 34) turn off the first to third relay circuits 26, 28, 36 based on the feature that the amount of current detected by the first to third current sensors 27, 29, 37 have reached the current amount indicating that the first to third lower-level ECUs 40, 50, 60 are in a hibernation state. Therefore, when the first to third lower-level ECUs 40, 50, 60 are in an operation state, it is possible to avoid interruption of the supply of power to the first to third lower-level ECUs 40, 50, 60. In other words, the power supply to the first to third lower-level ECUs 40, 50, 60 can be cut off at a proper timing when the first to third lower-level ECUs 40, 50, 60 are in a hibernation state.

### Second Embodiment

Next, a second embodiment of the in-vehicle system 100 and the control method for the in-vehicle system 100 according to the present embodiments will be described. The in-vehicle system 100 according to this embodiment is configured similarly to the in-vehicle system 100 according to the first embodiment. Therefore, a description of the configuration of the in-vehicle system 100 according to the second embodiment will be omitted.

According to the first embodiment, the first and second intermediate-level ECUs 20, 30 turn off the first to third relay circuits 26, 28, 36 when the acquired vehicle state information and/or the received communication message indicates that the first to third relay circuits 26, 28, 36 should be turned off and when the amount of current detected by the current sensors 27, 29, 36 on the power supply line is an amount of current that indicates that the lower-level ECUs 40, 50, 60 are in a hibernation state.

In contrast, in this embodiment, the first and second intermediate-level ECUs 20, 30 are configured to turn off the first to third relay circuits 26, 28, 36 when the amounts of current detected by the first to third current sensors 27, 29, 36 are the current amounts that indicate the first to third lower-level ECUs 40, 50, 60 are in a hibernation state. This is because the first to third lower-level ECUs 40, 50, 60 may include lower ECUs that, when activated and go into an operation state, execute a specific control process a predetermined number of times (for example, once) and then go into a hibernation state.

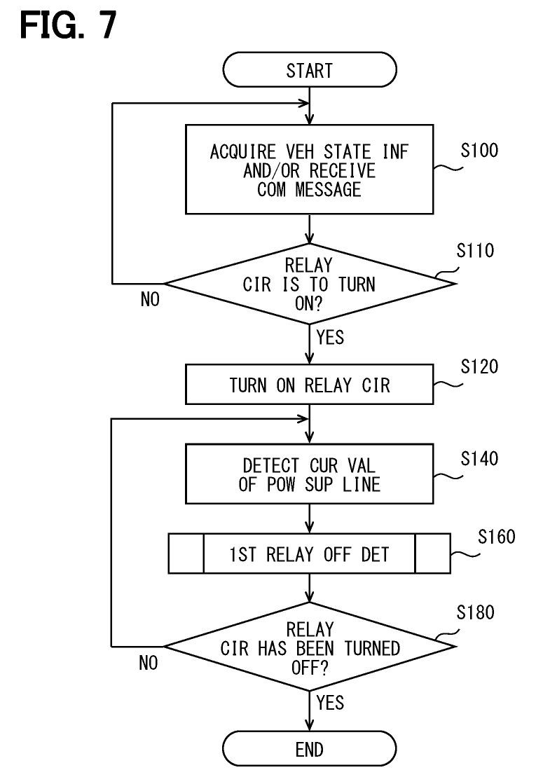

The flowchart in FIG. 7 shows the processing executed by the first and second intermediate-level ECUs 20, 30 when the first to third relay circuits 26, 28, 36 are turned off in response to the amounts of current detected by the first to third current sensors 27, 29, 36 being the current amounts that indicate the hibernation states of the first to third lower-level ECUs 40, 50, 60.

In the flowchart of FIG. 7, the vehicle state information and/or the communication message are not taken into consideration when the first to third relay circuits 26, 28, 36 are turned off, and therefore steps S130, S150, and S170 in the flowchart of FIG. 3 are omitted. The other processes in the flowchart of FIG. 7 are the same as those in the flowchart of FIG. 3, and therefore will not be described again. The processing shown in the flowchart of FIG. 7 and the processing shown in the flowchart of FIG. 3 may be used separately for each of the first to third lower-level ECUs 40, 50, 60 depending on how the control process is executed by the lower-level ECUs 40, 50, 60 (i.e., whether the control process is executed a predetermined number of times or whether the control process is executed repeatedly as long as a specific vehicle state continues).

Furthermore, as described above, when the first and second intermediate-level ECUs 20, 30 turn off the first to third relay circuits 26, 28, 36 in accordance with the amount of current detected by the first to third current sensors 27, 29, 36 being a current amount indicating the hibernation state of the first to third lower-level ECUs 40, 50, 60, the first to third lower-level ECUs 40, 50, 60 do not necessarily have to be configured to be able to communicate with other ECUs via the communication buses 44, 54, 64.

### Third Embodiment

Next, a third embodiment of the in-vehicle system 100 and the control method for the in-vehicle system 100 according to the present embodiments will be described. The in-vehicle system 100 according to this embodiment is configured similarly to the in-vehicle system 100 according to the first embodiment. Therefore, a description of the configuration of the in-vehicle system 100 according to the third embodiment will be omitted.

In the first embodiment, when the amount of current detected by the first to third current sensors 27, 29, and 36 becomes equal to or less than the second threshold, it is determined that an open circuit failure has occurred. In contrast to this, in this embodiment, the occurrence of an anomaly such as an open circuit failure is determined by taking into consideration the history of changes in the amount of current detected by the current sensors 27, 29, and 36 on the power supply lines. Therefore, in this embodiment, the first and second intermediate-level ECUs 20, 30 store the amounts of current detected by the first to third current sensors 27, 29, 37 for a certain period of time in the past.

When the first to third lower-level ECUs 40, 50, 60 are supplied with power and operating normally, the first to third lower-level ECUs 40, 50, 60 execute a predetermined control process in the beginning. When the predetermined control process is completed, the first to third lower-level ECUs 40, 50, 60 execute a predetermined termination process. Then, when the predetermined termination process is completed, the first to third lower-level ECUs 40, 50, 60 enter a hibernation state.

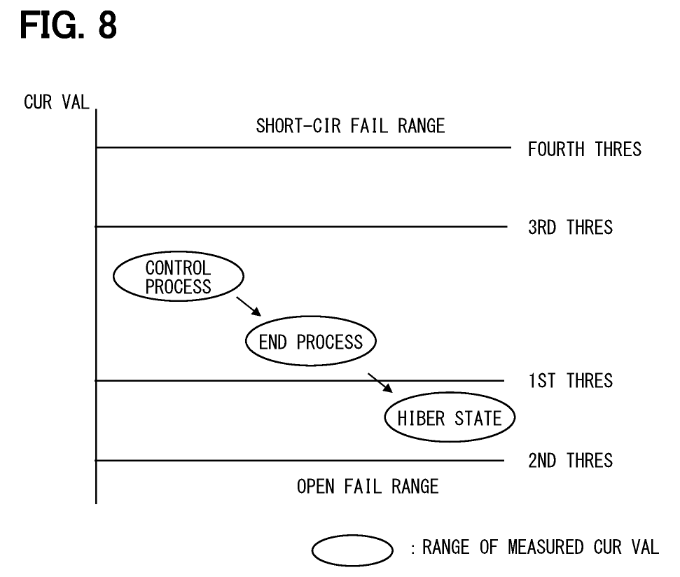

Therefore, when the first to third lower-level ECUs 40, 50, 60 transition to a hibernation state, the amount of current detected by the current sensors 27, 29, 36 on the power supply line should change from the range of current when the control process is being executed, through the range of current when the termination process is being executed, to the range of current when the hibernation state is entered, as shown in FIG. 8.

Therefore, when the amount of current detected by the current sensors 27, 29, 36 on the power supply line becomes an amount of current that indicates a hibernation state less than the first threshold, and the history of changes in the amount of current indicates that the first to third lower-level ECUs 40, 50, 60 are executing a predetermined control process, then that the first to third lower-level ECUs 40, 50, 60 are executing a predetermined termination process, and finally that the first to third lower-level ECUs 40, 50, 60 are in a hibernation state, it can be determined that the first to third lower-level ECUs 40, 50, 60 have normally entered into a hibernation state. In this case, the first and second intermediate-level ECUs 20, 30 turn off the first to third relay circuits 26, 28, 36 in response to the first to third lower-level ECUs 40, 50, 60 going into the hibernation state.

Conversely, when the history of changes in the amount of current does not indicate that the first to third lower-level ECUs 40, 50, 60 have transitioned from a state in which a predetermined control process is being executed, through a state in which a predetermined termination process is being executed, to a state in which the first to third lower-level ECUs 40, 50, 60 are in a hibernation state, and the amount of current detected by the first to third current sensors 27, 29, 36 becomes a current amount indicating a state in which the first to third lower-level ECUs 40, 50, 60 are in a hibernation state and the current amount is less than the first threshold value, it can be assumed that an anomaly such as an open circuit failure has occurred in at least one of the power supply line, the first to third relay circuits 26, 28, 36, and the lower-level ECUs 40, 50, 60. Therefore, in such a case, the first and second intermediate-level ECUs 20, 30 turn off the first to third relay circuits 26, 28, 36, and execute the process such as storing the information of the occurrence of an anomaly and notifying other ECUs of the occurrence of an anomaly.

### Modifications

One exemplary embodiment of the present disclosure is explained above. The present disclosure is not limited to the above-described embodiment, and can be implemented by various modifications without departing from the spirit of the present disclosure.

### Modification 1

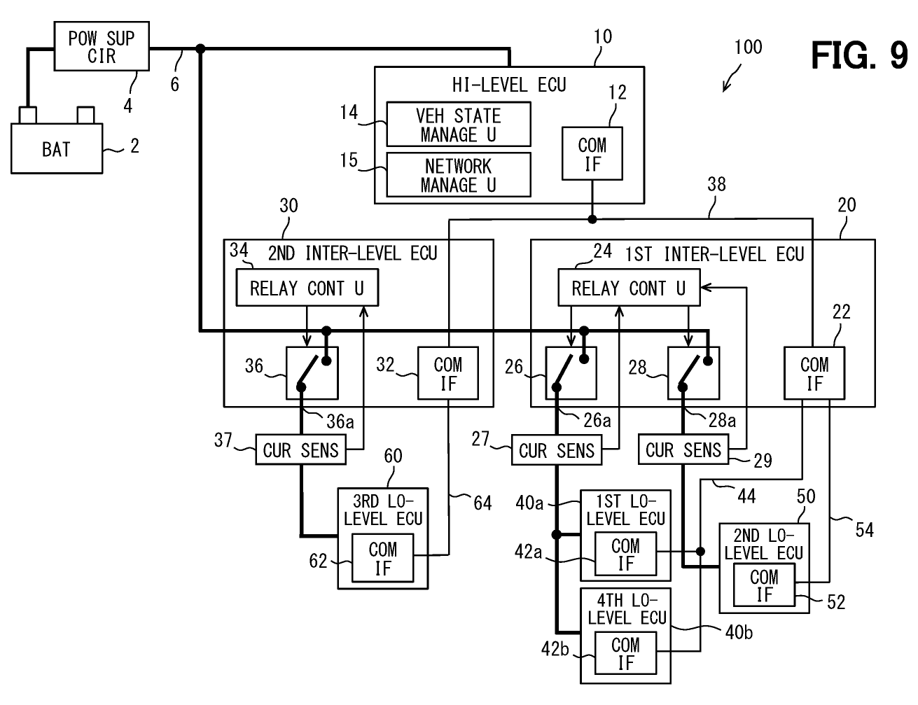

For example, in the first to third embodiments described above, an example has been described in which one lower-level ECU 40, 50, 60 is connected to each of the relay circuits 26, 28, 36. However, as shown in FIG. 9, for example, two or more lower-level ECUs 40a, 40b may be connected to one relay circuit 26. In this case, the communication IFs 42a and 42b of the respective lower-level ECUs 40a and 40b can both be connected to the communication bus 44.

In this way, when two or more lower-level ECUs 40a, 40b are connected to one relay circuit 26, the first threshold value shown in FIG. 6 is set so as to distinguish between a case where the two or more lower-level ECUs 40a, 40b are all in a hibernation state and a case where at least one of the two or more lower-level ECUs 40a, 40b is in an operation state. The third threshold value shown in FIG. 6 is set based on the maximum amount of current that is passed through each of the two or more lower-level ECUs 40a, 40b in an operation state in which all of the two or more lower-level ECUs 40a, 40b are in operation.

As a result, when the amount of current detected by the current sensor 27 becomes less than the first threshold value, the first intermediate-level ECU 20 can determine that all of the two or more lower-level ECUs 40a, 40b have entered a hibernation state, and can turn off the first relay circuit 26.

### Modification 2

The system and the method thereof described in the present disclosure may be implemented by a special purpose computer, which includes a processor programmed to provide one or more functions performed by computer programs. The systems and methods described in this disclosure may be implemented using a dedicated hardware logic circuit. The system, and the method thereof described in the present disclosure may be implemented by one or more dedicated computers configured by a combination of a processor that executes a computer program and one or more hardware logic circuitries. For example, some or all of the functions provided by the higher-level ECU 10, the first and second intermediate-level ECUs 20 and 30, and the first to third lower-level ECUs 40, 50, and 60 may be implemented as hardware. A configuration in which certain function is implemented by hardware logic circuitry includes a configuration in which the function is implemented using one or more ICs or the like. Some or all of the functions provided by the higher-level ECU 10, the first and second intermediate-level ECUs 20 and 30, and the first to third lower-level ECUs 40, 50, and 60 may be implemented using any of a system-on-chip (SoC), an integrated circuit (IC), or a field-programmable gate array (FPGA).

The concept of IC also includes ASICs (Application Specific Integrated Circuits). The computer program described above may be stored in a computer-readable non-transitory tangible storage medium as instructions to be executed by a computer. As a storage medium for storing the computer program, a hard disk drive (i.e., HDD), a solid state drive (i.e., SSD), a flash memory, or the like can be adopted. Furthermore, a program for causing a computer to function as the higher-level ECU 10, the first and second intermediate-level ECUs 20 and 30, and the first to third lower-level ECUs 40, 50, and 60, as well as non-transitory tangible storage media such as semiconductor memory or the like on which such a program is stored, are also encompassed within the scope of the present embodiments.

### Embodiments of Technical Features

This specification discloses multiple technical features described in multiple items listed below. Some items may be described in multiple dependent form to refer to more than one preceding items in the alternative. Further, some items may be written in multiple dependent form, referencing multiple items that include other items in multiple dependent form. These items described in a multiple dependent form define multiple technical features. Furthermore, the technical features described in the following paragraphs also apply to a control method for an in-vehicle network system.

### Technical feature 1

An in-vehicle system (100) includes a plurality of control devices (10, 20, 30, 40, 50, 60) mounted on a vehicle. The plurality of control devices include at least one lower-level control device (40, 50, 60) and at least one higher-level control device (20, 30) disposed in a higher level of the at least one lower-level control device. The at least one higher-level control device has a relay control unit (24, 34) that turns on or off a relay circuit (26, 28, 36) provided in a power supply line (6) of the at least one lower-level control device. The in-vehicle system further includes a current detection unit (27, 29, 37) that detects an amount of current flowing through the power supply line of the at least one lower-level control device. The relay control unit is configured to turn off the relay circuit when the amount of current detected by the current detection unit reaches a predetermined amount of current that indicates a hibernation state of the at least one lower-level control device.

### Technical feature 2

In the in-vehicle system described in technical feature 1, the at least one lower control device is capable of executing a predetermined process when power is supplied via the relay circuit, and enters the hibernation state upon completion of execution of the predetermined process.

### Technical feature 3

In the in-vehicle system described in technical feature 1 or 2, the relay control unit turns on the relay circuit in response to vehicle state information regarding a state of the vehicle and/or in response to receiving a communication message from another control device indicating that the relay circuit is required to be turned on.

### Technical feature 4

In the in-vehicle system described in any one of technical features 1 to 3, the relay control unit maintains the relay circuit to be an on state when the amount of current detected by the current detection unit is an amount of current indicating that the at least one lower-level control device is operating although vehicle state information relating to a state of the vehicle and/or a communication message received from another control device indicates that the relay circuit is required to be turned off.

### Technical feature 5

In the in-vehicle system described in any one of technical features 1 to 4, the relay control unit turns off the relay circuit when vehicle status information relating to a state of the vehicle and/or a communication message received from another control device indicates that the relay circuit is required to be turned off, and the amount of current detected by the current detection unit is an amount of current indicating the hibernation state of the at least one lower-level control device.

### Technical feature 6

The in-vehicle system described in any one of technical features 1 to 5 further includes a further higher-level control device (10) disposed in a higher level of the at least one higher-level control device. The further higher-level control device provides at least a part of the vehicle state information to the higher-level control device, and/or, as another control device, transmits a communication message indicating that the relay circuit is to be turned on or off.

### Technical feature 7

In the in-vehicle system described in any one of technical features 1 to 6, the at least one lower-level control device includes at least two lower-level control devices (40a, 40b) connected to the power supply line provided with the relay circuit. The relay control unit turns off the relay circuit based on a feature that the amount of current detected by the current detection unit reaches an amount of current indicating that the at least two lower-level control devices have all entered the hibernation state.

### Technical feature 8

In the in-vehicle system described in any one of technical features 1 to 7, the relay control unit determines that the amount of current detected by the current detection unit reaches an amount of current indicating the hibernation state of the at least one lower control device when the amount of current detected by the current detection unit is smaller than a first threshold value predetermined for distinguishing between the hibernation state of the at least one lower control device and an operation state in which the at least one lower control device is operating.

### Technical feature 9

In the in-vehicle system described in technical feature 8, the relay control unit determines that an open circuit failure has occurred in at least one of the power supply line, the relay circuit, and the at least one lower-level control device when the amount of current detected by the current detection unit becomes smaller than a second threshold value set to be smaller than the first threshold value.

### Technical feature 10

In the in-vehicle system described in any one of technical features 1 to 9, the relay control unit turns off the relay circuit when the amount of current detected by the current detection unit becomes greater than a third threshold value preliminarily set based on a maximum amount of current flowing through the at least one lower-level control device when the at least one lower-level control device is in an operation state in which the at least one lower-level control device is operating.

### Technical feature 11

In the in-vehicle system described in technical feature 10, the relay control unit determines that a short circuit failure has occurred in at least one of the power supply line, the relay circuit, and the at least one lower-level control device when the amount of current detected by the current detection unit becomes greater than a fourth threshold value set to be greater than the third threshold value.

### Technical feature 12

In the in-vehicle system described in any one of technical features 1 to 11, the at least one lower control device can execute a predetermined process by receiving power via the relay circuit. The predetermined process includes a predetermined control process and a predetermined termination process. When an execution of the predetermined control process is completed, the at least one lower control device enters the hibernation state after executing the predetermined termination process. The amount of current flowing through the at least one lower control device is different when the at least one lower control device is executing the predetermined control process, when the at least one lower control device is executing the predetermined termination process, and when the at least one lower control device is in the hibernation state. The relay control unit turns off the relay circuit when the amount of current detected by the current detection unit is a current amount indicating the hibernation state of the at least one lower control device and a history of changes in the amount of current indicates that the at least one lower control device has transitioned from an execution state of the predetermined control process to the hibernation state via an execution state of the predetermined termination process.

### Technical feature 13

In the in-vehicle system described in technical feature 12, the relay control unit determines that an open circuit failure has occurred in at least one of the power supply line, the relay circuit, and the at least one lower control device when the history of changes in the amount of current detected by the current detection unit does not indicate that the at least one lower control device has transitioned from an execution state of the predetermined control process to the hibernation state through the execution state of the predetermined termination process, and the amount of current detected by the current detection unit reaches a current amount indicating the hibernation state of the at least one lower control device.

### Technical feature 14

In the in-vehicle system described in any one of technical features 9, 11 and 13, the relay control unit stores an occurrence of a corresponding failure when it determines that the open circuit failure or the short circuit failure has occurred in at least one of the power supply line, the relay circuit, and the at least one lower-level control device.

### Technical feature 15

In the in-vehicle system described in technical feature 14, the relay control unit further transmits a communication message to the another control device to notify the another control device of the occurrence of the corresponding failure when it is determined that the open circuit failure or the short circuit failure has occurred in at least one of the power supply line, the relay circuit, and the at least one lower-level control device.

Reference numeral 2 indicates a battery, reference numeral 4 indicates a power supply circuit, reference numeral 6 indicates a power supply line, reference numeral 10 indicates a higher-level ECU, reference numeral 12 indicates a communication IF, reference numeral 14 indicates a vehicle state management unit, reference numeral 15 indicates a network management unit, reference numeral 20 indicates a first intermediate-level ECU, reference numeral 22 indicates a communication IF, reference numeral 24 indicates a first relay control unit, reference numeral 26 indicates a first relay circuit, reference numeral 27 indicates a first current sensor, reference numeral 28 indicates a second relay circuit, reference numeral 29 indicates a second current sensor, reference numeral 30 indicates a second intermediate-level ECU, reference numeral 32 indicates a communication IF, reference numeral 34 indicates a second relay control unit, reference numeral 36 indicates a third relay circuit, reference numeral 37 indicates a third current sensor, reference numeral 38 indicates a communication bus, reference numeral 40 indicates a first lower-level ECU, reference numeral 42 indicates a communication IF, reference numeral 44 indicates a communication bus, reference numeral 50 indicates a second lower-level ECU, reference numeral 52 indicates a communication IF, reference numeral 54 indicates a communication bus, reference numeral 60 indicates a third lower-level ECU, reference numeral 62 indicates a communication IF, reference numeral 64 indicates a communication bus, and reference numeral 100 indicates an in-vehicle system.

It is noted that a flowchart or the processing of the flowchart in the present application includes sections (also referred to as steps), each of which is represented, for instance, as S100. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An in-vehicle system comprising:
a plurality of control devices mounted on a vehicle, wherein:
the plurality of control devices include at least one lower-level control device and at least one higher-level control device disposed in a higher level of the at least one lower-level control device; and
the at least one higher-level control device has a relay controller that turns on or off a relay circuit provided in a power supply line of the at least one lower-level control device,
the in-vehicle system further comprising:
a current detector that detects an amount of current flowing through the power supply line of the at least one lower-level control device, wherein:
the relay controller is configured to turn off the relay circuit when the amount of current detected by the current detector reaches a predetermined amount of current that indicates a hibernation state of the at least one lower-level control device.

2. The in-vehicle system according to claim 1, wherein:
the at least one lower control device is capable of executing a predetermined process when power is supplied via the relay circuit, and enters the hibernation state upon completion of execution of the predetermined process.

3. The in-vehicle system according to claim 1, wherein:
the relay controller turns on the relay circuit in response to vehicle state information relating to a state of the vehicle and/or in response to receiving a communication message from another control device, indicating that the relay circuit is required to be turned on.

4. The in-vehicle system according to claim 1, wherein:
the relay controller maintains the relay circuit to be an on state when the amount of current detected by the current detector is an amount of current indicating that the at least one lower-level control device is operating although vehicle state information relating to a state of the vehicle and/or a communication message received from another control device indicates that the relay circuit is required to be turned off.

5. The in-vehicle system according to claim 1, wherein:
the relay controller turns off the relay circuit when vehicle state information relating to a state of the vehicle and/or a communication message received from another control device indicates that the relay circuit is required to be turned off, and the amount of current detected by the current detector is an amount of current indicating a hibernation state of the at least one lower-level control device.

6. The in-vehicle system according to claim 3, further comprising:
a further higher-level control device disposed in a higher level of the at least one higher-level control device, wherein:
the further higher-level control device provides at least a part of the vehicle state information to the higher-level control device, and/or, as another control device, transmits a communication message indicating that the relay circuit is to be turned on or off.

7. The in-vehicle system according to claim 1, wherein:
the at least one lower-level control device includes at least two lower-level control devices connected to the power supply line provided with the relay circuit; and
the relay controller turns off the relay circuit based on a feature that the amount of current detected by the current detector reaches an amount of current indicating that the at least two lower-level control devices have all entered a hibernation state.

8. The in-vehicle system according to claim 1, wherein:
the relay controller determines that the amount of current detected by the current detector reaches an amount of current indicating a hibernation state of the at least one lower control device when the amount of current detected by the current detector is smaller than a first threshold value preliminarily determined for distinguishing between the hibernation state of the at least one lower control device and an operation state in which the at least one lower control device is operating.

9. The in-vehicle system according to claim 8, wherein:
the relay controller determines that an open circuit failure has occurred in at least one of the power supply line, the relay circuit, and the at least one lower-level control device when the amount of current detected by the current detector becomes smaller than a second threshold value set to be smaller than the first threshold value.

10. The in-vehicle system according to claim 9, wherein:
the relay controller stores an occurrence of the open circuit failure when it determines that the open circuit failure has occurred in at least one of the power supply line, the relay circuit, and the at least one lower-level control device.

11. The in-vehicle system according to claim 10, wherein:
the relay controller further transmits a communication message to another control device to notify the another control device of the occurrence of the open circuit failure when it is determined that the open circuit failure has occurred in at least one of the power supply line, the relay circuit, and the at least one lower-level control device.

12. The in-vehicle system according to claim 1, wherein:
the relay controller turns off the relay circuit when the amount of current detected by the current detector becomes greater than a third threshold value preliminarily set based on a maximum amount of current flowing through the at least one lower-level control device when the at least one lower-level control device is in an operation state in which the at least one lower-level control device is operating.

13. The in-vehicle system according to claim 12, wherein:
the relay controller determines that a short circuit failure has occurred in at least one of the power supply line, the relay circuit, and the at least one lower-level control device when the amount of current detected by the current detector becomes greater than a fourth threshold value set to be greater than the third threshold value.

14. The in-vehicle system according to claim 13, wherein:
the relay controller stores an occurrence of the short circuit failure when it determines that the short circuit failure has occurred in at least one of the power supply line, the relay circuit, and the at least one lower-level control device.

15. The in-vehicle system according to claim 14, wherein:
the relay controller further transmits a communication message to another control device to notify the another control device of the occurrence of the short circuit failure when it is determined that the short circuit failure has occurred in at least one of the power supply line, the relay circuit, and the at least one lower-level control device.

16. The in-vehicle system according to claim 1, wherein:
the at least one lower control device can execute a predetermined process by receiving power via the relay circuit;
the predetermined process includes a predetermined control process and a predetermined termination process;
when an execution of the predetermined control process is completed, the at least one lower control device enters a hibernation state after executing the predetermined termination process;
the amount of current flowing through the at least one lower control device is different among when the at least one lower control device is executing the predetermined control process, when the at least one lower control device is executing the predetermined termination process, and when the at least one lower control device is in the hibernation state; and
the relay controller turns off the relay circuit when the amount of current detected by the current detector is a current amount indicating the hibernation state of the at least one lower control device and a history of changes in the amount of current indicates that the at least one lower control device has transitioned from an execution state of the predetermined control process to the hibernation state via an execution state of the predetermined termination process.

17. The in-vehicle system according to claim 16, wherein:
the relay controller determines that an open circuit failure has occurred in at least one of the power supply line, the relay circuit, and the at least one lower control device when the history of changes in the amount of current detected by the current detector does not indicate that the at least one lower control device has transitioned from the execution state of the predetermined control process to the hibernation state through the execution state of the predetermined termination process, and the amount of current detected by the current detector reaches a current amount indicating the hibernation state of the at least one lower control device.

18. The in-vehicle system according to claim 17, wherein:
the relay controller stores an occurrence of the open circuit failure when it determines that the open circuit failure has occurred in at least one of the power supply line, the relay circuit, and the at least one lower-level control device.

19. The in-vehicle system according to claim 18, wherein:
the relay controller further transmits a communication message to another control device to notify the another control device of the occurrence of the open circuit failure when it is determined that the open circuit failure has occurred in at least one of the power supply line, the relay circuit, and the at least one lower-level control device.

20. A method for controlling an in-vehicle system including a plurality of control devices mounted on a vehicle, wherein:
the plurality of control devices include at least one lower-level control device and at least one higher-level control device disposed in a higher level of the at least one lower-level control device;
the at least one higher-level control device has a relay controller that turns on or off a relay circuit provided in a power supply line of the at least one lower-level control device; and
the in-vehicle system further includes a current detector that detects an amount of current flowing through the power supply line of the at least one lower-level control device,
the method for controlling the in-vehicle system comprising:
detecting the amount of current flowing through the power supply line by the current detector; and
turning off the relay circuit by the relay controller when the amount of current detected by the current detector reaches a predetermined amount of current that indicates a hibernation state of the at least one lower-level control device.
